(19) United States
(12) Patent Application Publication
(10) Pub. No.: US 2024/0193223 A1
(43) Pub. Date: Jun. 13, 2024

(54) OPTIMIZATION SYSTEM, OPTIMIZATION METHOD, AND RECORDING MEDIUM

(71) Applicant: NEC Corporation, Tokyo (JP)

(72) Inventors: Ryutaro DOI, Tokyo (JP); Yuta Ideguchi, Tokyo (JP)

(73) Assignee: NEC Corporation, Tokyo (JP)

(21) Appl. No.: 18/530,614

(22) Filed: Dec. 6, 2023

(30) Foreign Application Priority Data
Dec. 12, 2022 (JP) 2022-197578

(51) Int. Cl. G06F 17/11; G06F 17/18

(52) U.S. Cl. CPC G06F 17/11; G06F 17/18

(57) ABSTRACT

An artificial intelligence (AI) system solves an optimization problem by a heuristic solution, calculates statistical information of the solution based on the solution obtained by solving, and outputs the statistical information to a terminal device of a user.

This application is based upon and claims the benefit of priority from Japanese Patent Application No. 2022-197578, filed on Dec. 12, 2022, the disclosure of which is incorporated herein in its entirety by reference.

### TECHNICAL FIELD

The present disclosure relates to an optimization system and the like.

### BACKGROUND ART

A wide range of real social problems may be formulated into a combinatorial optimization problem. Here, the optimization problem is a problem of obtaining a solution that minimizes or maximizes the objective function among solutions that satisfy the constraint condition. For example, an annealing method may be adopted as one of the main solving methods of the combinatorial optimization problem.

For example, Patent Literature 1 (WO 2018/168383 A) describes a technique of obtaining a large number of solutions, estimating the maximum likelihood of an evaluation value of an optimal solution on the assumption that the optimal solution follows a general extreme value distribution, and comparing the evaluation value of the obtained solution with the evaluation value of the estimated optimal solution.

### SUMMARY

An object of the present disclosure is to provide an optimization system and the like that facilitate confirmation of optimality of a solution obtained by an optimization problem in a heuristic solution.

An optimization system according to an aspect of the present disclosure includes an optimization processing means that solves an optimization problem by a heuristic solution, a calculation means that calculates statistical information of a solution based on the solution obtained by the optimization processing means, and an output control means that presents the statistical information to a user.

An optimization method according to an aspect of the present disclosure solves an optimization problem by a heuristic solution; calculates statistical information of a solution based on the solution obtained by the solving; and presents the statistical information to a user.

A program according to an aspect of the present disclosure causes a computer to execute: solving an optimization problem by a heuristic solution; calculating statistical information of a solution based on the solution obtained by the solving; and presenting the statistical information to a user.

The program may be stored in a non-transitory recording medium which can computer-readable.

### BRIEF DESCRIPTION OF THE DRAWINGS

Exemplary features and advantages of the present invention will become apparent from the following detailed description when taken with the accompanying drawings in which:

FIG. 1 is an explanatory diagram illustrating an example of a heuristic solution of a combinatorial optimization problem;

FIG. 2 is a first block diagram illustrating a configuration example of an optimization system of the present disclosure;

FIG. 3 is a flowchart illustrating an operation example of the optimization system of the present disclosure;

FIG. 4 is an explanatory diagram illustrating an example of connection between an optimization system and a terminal device;

FIG. 5 is a second block diagram illustrating a configuration example of the optimization system of the present disclosure;

FIG. 6 is an explanatory diagram illustrating a first presentation example of statistical information;

FIG. 7 is an explanatory diagram illustrating a second presentation example of statistical information;

FIG. 8 is an explanatory diagram illustrating an example of setting an annealing time in the next solving;

FIG. 9 is a flowchart illustrating a first operation example of the optimization system of the present disclosure;

FIG. 10 is an explanatory diagram illustrating a detailed block diagram of an optimization processing unit in a case where a solving process is parallelized;

FIG. 11 is an explanatory diagram illustrating an example of displaying statistical information in real time;

FIG. 12 is a flowchart illustrating a second operation example of the optimization system of the present disclosure;

FIG. 13 is a flowchart illustrating a third operation example of the optimization system of the present disclosure;

FIG. 14 is an example of a table illustrating a work shift of a medical worker belonging to a certain organization; and

FIG. 15 is an explanatory diagram illustrating an exemplary hardware configuration of a computer.

### EXAMPLE EMBODIMENT

Hereinafter, example embodiments of an optimization system, an optimization method, a program, and a non-transitory recording medium recording the program according to the present disclosure will be described in detail with reference to the drawings. The present example embodiment does not limit the disclosed technology.

In each example embodiment, an optimization problem is solved by a heuristic solution. Heuristic solutions include simulated annealing (SA) methods, evolutionary algorithms, tabu search, group intelligence, and the like.

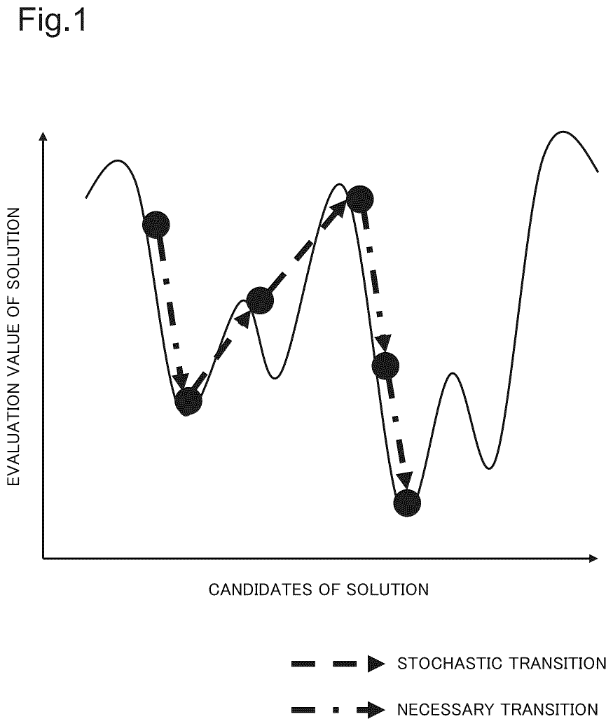

FIG. 1 is an explanatory diagram illustrating an example of a heuristic solution of a combinatorial optimization problem. Here, a simulated annealing (SA) method will be described as an example of a heuristic solution. In the SA method, a solution space is searched by repeating transition from a random initial state to a nearby solution. In FIG. 1, in the graph, the vertical axis represents the evaluation value of the solution candidate, and the horizontal axis represents the solution candidate. Here, the lower the evaluation value of the solution candidate, the better. For example, in the SA method, if the evaluation value of the nearby solution is better than the evaluation value of the solution candidate in the current state, the state transitions, and if the evaluation value of the nearby solution is worse than the evaluation value of the solution candidate in the current state, the state transitions stochastically. In FIG. 1, a broken line represents a stochastic transition, and a one-dot broken line represents a transition of a necessary state.

Here, in the heuristic solution, it is theoretically guaranteed that an optimal solution is reached by performing an infinite time solving. However, in reality, in the heuristic solution, a finite time solving is performed. Therefore, in the SA method, the annealing time is set in advance, and the solving is performed at the annealing time. There is a correlation between the annealing time and the number of transitions in the graph of FIG. 1. In the following description, the unit of the annealing time is seconds.

### First Example Embodiment

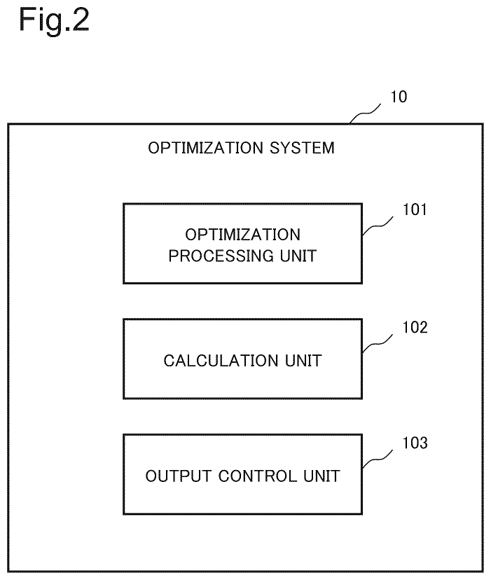

First, in a first example embodiment, a basic function of a control system will be described. FIG. 2 is a block diagram illustrating a configuration example of an optimization system 10 of the present disclosure. The optimization system 10 includes an optimization processing unit 101, a calculation unit 102, and an output control unit 103.

The optimization processing unit 101 solves the optimization problem by a heuristic solution. Here, the type of the problem information of the optimization problem is not particularly limited. The heuristic solution is, for example, the SA method. The optimization processing unit 101 iteratively solves the optimization problem, for example.

The calculation unit 102 calculates statistical information of the solution based on the solution obtained by the solving by the optimization processing unit 101. Here, the statistical information is, for example, at least one of a variance of solutions, a confidence interval of solutions, a standard deviation of solutions, an average value of solutions, a median value of solutions, and a histogram of solutions. The histogram is a graph in which the vertical axis is the frequency of the solution and the horizontal axis is the solution.

The statistical information may be statistical information of the evaluation value of the solution. The statistical information of the evaluation values of the solutions is, for example, at least one of a variance of the evaluation values of the solutions, a confidence interval of the evaluation values of the solutions, a standard deviation of the evaluation values of the solutions, an average value of the evaluation values of the solutions, a median value of the evaluation values of the solutions, and a histogram of the evaluation values of the solutions. The histogram is a graph in which the vertical axis is the frequency of the evaluation value of the solution and the horizontal axis is the evaluation value of the solution.

The output control unit 103 presents the statistical information calculated by the calculation unit 102 to the user. The output control unit 103 output the statistical information to the terminal device of the user. Specifically, for example, the output control unit 103 display the statistical information on the terminal device of the user to display. The specific display example will be described in detail with reference to the second example embodiment.

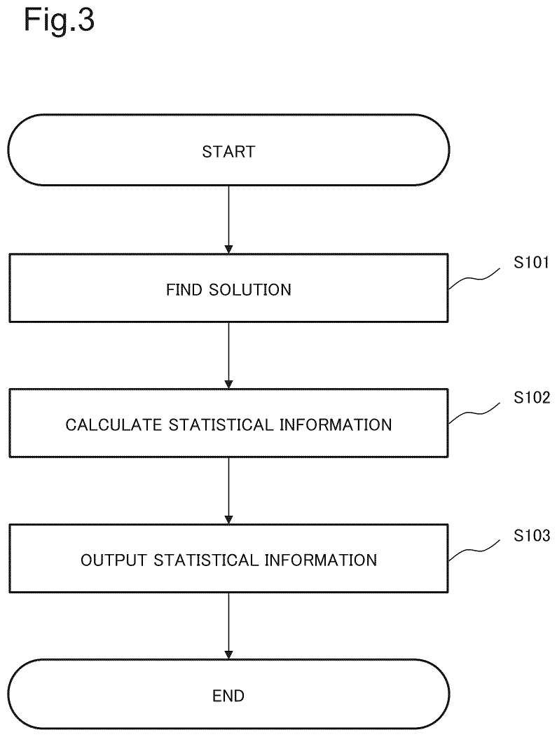

FIG. 3 is a flowchart illustrating an operation example of the optimization system 10 of the present disclosure. The optimization processing unit 101 solves the optimization problem by a heuristic solution (step S101). Next, the calculation unit 102 calculates statistical information based on the solution obtained by the solving (step S102). Then, the output control unit 103 presents the statistical information to the user (step S103), and the optimization system 10 ends the processing.

As described above, since the heuristic solution includes a stochastic operation, the obtained solution is different every time the optimization problem is solved. Therefore, there is a problem that it is difficult to understand the optimality of the solution obtained by the optimization problem. The optimality of the solution is how close the solution is to the true solution.

There is a problem that it is difficult to understand whether the setting of the parameter related to the solving of the optimization problem is good or bad. For example, the parameter may be the number of times of solving or the time of solving, and is not particularly limited. In the heuristic solution, it is theoretically guaranteed that an optimal solution is reached by performing an infinite time solving. However, in reality, in the heuristic solution, a finite time solving is performed. For example, the parameter for solving the optimization problem may be the time or the number of times. In the case of the SA method, this time is also referred to as an annealing time.

In the first example embodiment, the optimization system 10 calculates the statistical information of the solution based on the solution obtained by the solving, and presents the calculated statistical information to the user. As a result, it is possible to give an indication on the solution variation. Therefore, the optimality of the solution can be easily confirmed. Furthermore, it is possible to obtain a solution having more optimality. The suggestion about the solution variation is a suggestion about the parameter adjustment. Consequently, the user can easily adjust the parameter. For example, if the heuristic solution is the SA method and the parameter is the annealing time, the annealing time can be shortened or lengthened.

### Second Example Embodiment

Hereinafter, a second example embodiment will be described in detail with reference to the drawings. In the second example embodiment, a specific example of displaying statistical information to a user and an example of solving a plurality of different initial states in parallel will be described. Hereinafter, description of contents overlapping with the above description will be omitted to the extent that the description of the second example embodiment is not unclear.

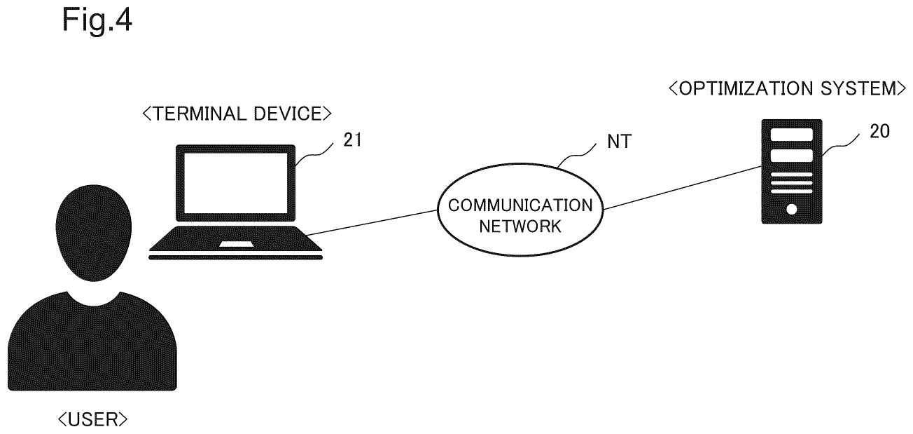

FIG. 4 is an explanatory diagram illustrating an example of connection between the optimization system and the terminal device. For example, an optimization system 20 receives an operation of the user or presents information to the user via a terminal device 21. For example, the optimization system 20 is connected to the terminal device 21 via a communication network NT.

For example, the terminal device 21 may be capable of displaying information from the optimization system 20, or an application program for transmitting information to the optimization system 20 may be installed in advance. For example, the terminal device 21 may access the optimization system 20 via the communication network NT.

The type of the terminal device 21 is not particularly limited to a personal computer (PC), a smartphone, a tablet-type device, and the like.

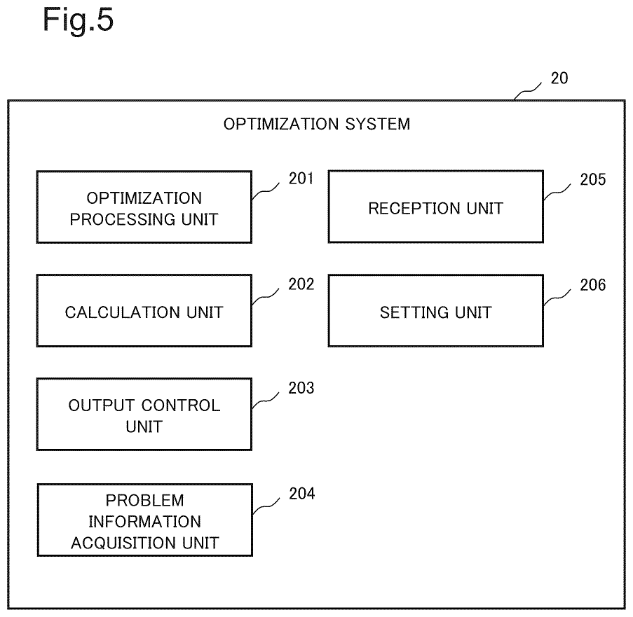

FIG. 5 is a second block diagram illustrating a configuration example of the optimization system 20 of the present disclosure. The optimization system 20 includes an optimization processing unit 201, a calculation unit 202, an output control unit 203, a problem information acquisition unit 204, a reception unit 205, and a setting unit 206 6. The optimization system 20 further includes a problem information acquisition unit 204, a reception unit 205, and a setting unit 206 in addition to those in the first example embodiment.

The optimization processing unit 201 has a basic function of the optimization processing unit 101 according to the first example embodiment. The calculation unit 202 has a basic function of the calculation unit 102 according to the first example embodiment. The output control unit 203 has a basic function of the output control unit 103 according to the first example embodiment.

The problem information acquisition unit 204 acquires problem information indicating an optimization problem. For example, the problem information acquisition unit 204 may acquire the problem information by receiving the problem information by the user's operation via the terminal device 21. Alternatively, the problem information acquisition unit 204 may acquire the problem information from a database or the like.

Next, the optimization processing unit 201 solves the optimization problem represented by the problem information by a heuristic solution. Here, for example, the heuristic solution is an annealing method as described above. For example, the optimization processing unit 201 repeatedly solves the optimization problem.

The calculation unit 202 calculates statistical information of the solution based on the solution obtained by the optimization processing unit 201. The statistical information is as described above. For example, the calculation unit 202 calculates statistical information of a solution based on a plurality of solutions obtained by at least two or more solving.

The output control unit 203 presents the statistical information to the user. The presentation method is not particularly limited. For example, the output control unit 203 displays the statistical information on the terminal device 21

For example, the calculation unit 202 may calculate statistical information of a new solution every time the optimization processing unit 201 obtains the new solution. Alternatively, for example, every time a predetermined number of new solutions are calculated by the optimization processing unit 201, the calculation unit 202 may calculate statistical information of the solutions. For example, the predetermined number is one or more. For example, in a case where the predetermined number is 5, the calculation unit 202 may calculate the statistical information of the solution every time the optimization processing unit 201 obtains five new solutions.

The output control unit 203 may present the statistical information to the user every time the statistical information is calculated. The output control unit 203 may present the statistical information in time series. The output control unit 203 may present at least one of the solution and the evaluation value of the solution and the statistical information in time series.

The reception unit 205 may receive a new solving request. Specifically, the reception unit 205 may receive a request for solving by a user's operation via the terminal device 21. Then, the reception unit 205 may receive the value of the parameter in the new solving. Specifically, the reception unit 205 receives the value of a parameter by a user's operation via the terminal device 21. The parameter may be an annealing time, as described above. The parameter may be a transition degree of a stochastic transition in the optimization problem. For example, in FIG. 1, the transition degree represents the degree of moving a stochastic transition represented by a broken line. The parameter may be a degree of compliance with a constraint condition in the optimization problem. For example, in FIG. 1, the degree of transition is changed by changing the degree of compliance.

Then, the setting unit 206 updates the value of the parameter to the value of the parameter received by the reception unit 205. The optimization processing unit 201 newly solves the optimization problem based on the value of the received parameter. In this case, the optimization processing unit 201 sets a new initial state in the optimization problem, and performs solving based on the value of the received parameter.

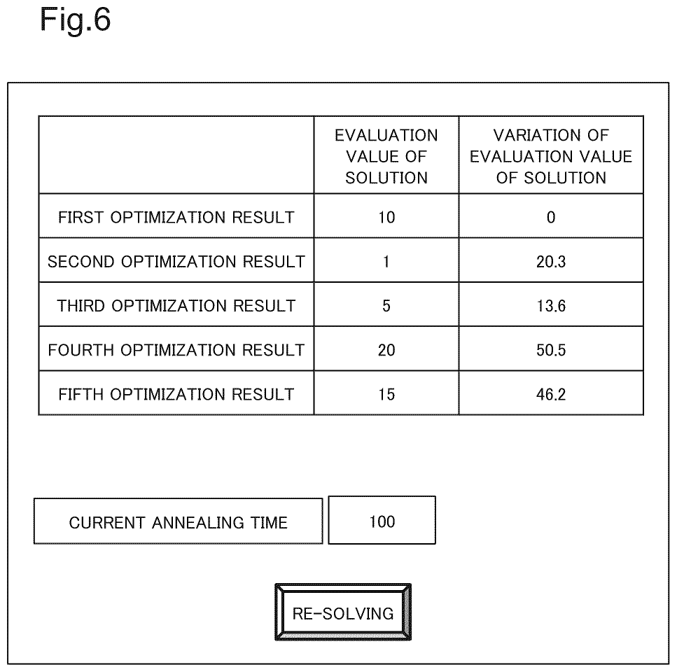

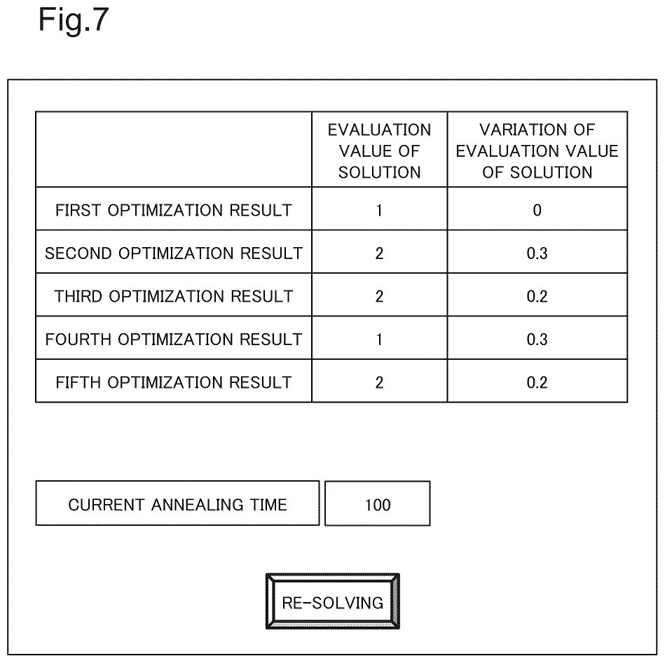

Here, an example of presenting statistical information and receiving a request for new solving will be described with reference to FIGS. 6 and 7.

FIG. 6 is an explanatory diagram illustrating a first presentation example of statistical information. In FIG. 6, the statistical information is a variance of the evaluation value of the solution. On the screen of the terminal device 21, the evaluation value of the solution and the variance of the evaluation value of the solution are displayed in time series. In FIG. 6, the currently set annealing time is displayed on the screen. The current annealing time is set to 100. The screen includes a re-solving button.

For example, the evaluation value of the first solution is 10, the evaluation value of the second solution is 1, the evaluation value of the third solution is 5, the evaluation value of the fourth solution is 20, and the evaluation value of the fifth solution is 15. The variance of the evaluation value of the first solution is 0, the variance of the evaluation value of the second solution is 20.3, the variance of the evaluation value of the third solution is 13.6, the variance of the evaluation value of the fourth solution is 50.5, and the variance of the evaluation value of the fifth solution is 46.2.

As a result, for example, the user can confirm the evaluation values of the solutions up to the fifth time and the variance of solutions. For example, in FIG. 6, the user can estimate that a better solution can be obtained by increasing the number of trials by referring to the screen. For example, in FIG. 6, the user can estimate that the variance can be suppressed by increasing the annealing time by referring to the screen. For example, the user may set the annealing time to be long when performing the sixth solving. For example, when the re-solving button is tapped, the reception unit 205 receives a new solving request.

FIG. 7 is an explanatory diagram illustrating a second presentation example of statistical information. In FIG. 7, the statistical information is a variance of the evaluation value of the solution. On the screen of the terminal device 21, the evaluation value of the solution and the variance of the evaluation value of the solution are displayed in time series. In FIG. 7, the currently set annealing time is displayed on the screen. The screen includes a re-solving button.

For example, the evaluation value of the first solution is 1, the evaluation value of the second solution is 2, the evaluation value of the third solution is 2, the evaluation value of the fourth solution is 1, and the evaluation value of the fifth solution is 2. The variance of the evaluation value of the first solution is 0, the variance of the evaluation value of the second solution is 0.3, the variance of the evaluation value of the third solution is 0.2, the variance of the evaluation value of the fourth solution is 0.3, and the variance of the evaluation value of the fifth solution is 0.2.

As a result, for example, the user can confirm the evaluation values of the solutions up to the fifth time and the variance of solutions. For example, in FIG. 7, the user can confirm that the solution has converged up to the fifth time by referring to the screen. As a result, the user can refer to the setting of the value of the parameter in the case of newly performing the solving. That is, the user may set the annealing time to be short when performing the sixth solving. For example, when the re-solving button is tapped, the reception unit 205 receives a new solving request.

For example, in FIGS. 6 and 7, when receiving a new request for solving, the reception unit 205 may receive setting of a new annealing time for the next solving.

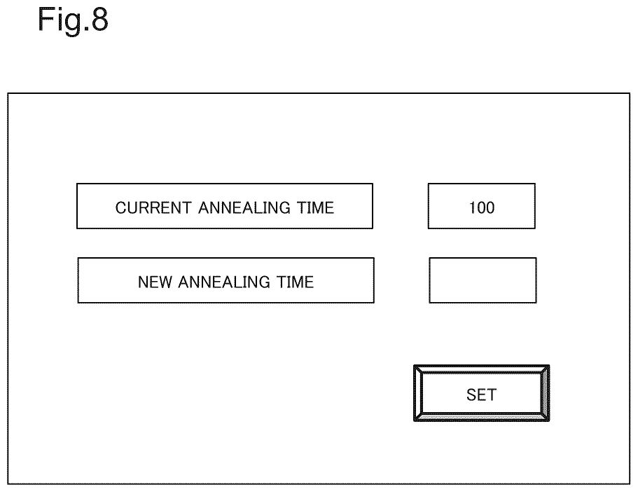

FIG. 8 is an explanatory diagram illustrating an example of setting an annealing time in the next solving. In FIG. 8, the current annealing time is displayed on the screen of the terminal device. The screen further includes an input field in which an annealing time in the next solving can be input, and a set button. For example, when the set button is pressed, the reception unit 205 receives a value input in the input field as a new annealing time.

The calculation unit 202 may calculate the statistical information based on the intermediate result of the solving by the optimization processing unit 201. Here, the intermediate result of the solving is an intermediate result of one solving. For example, the intermediate result of the solving is an optimal solution among solution candidates obtained by one transition in one solving process in the SA method. Here, one transition in one solving is also referred to as a unit step. Then, the output control unit may present the statistical information to the user every time the statistical information is calculated.

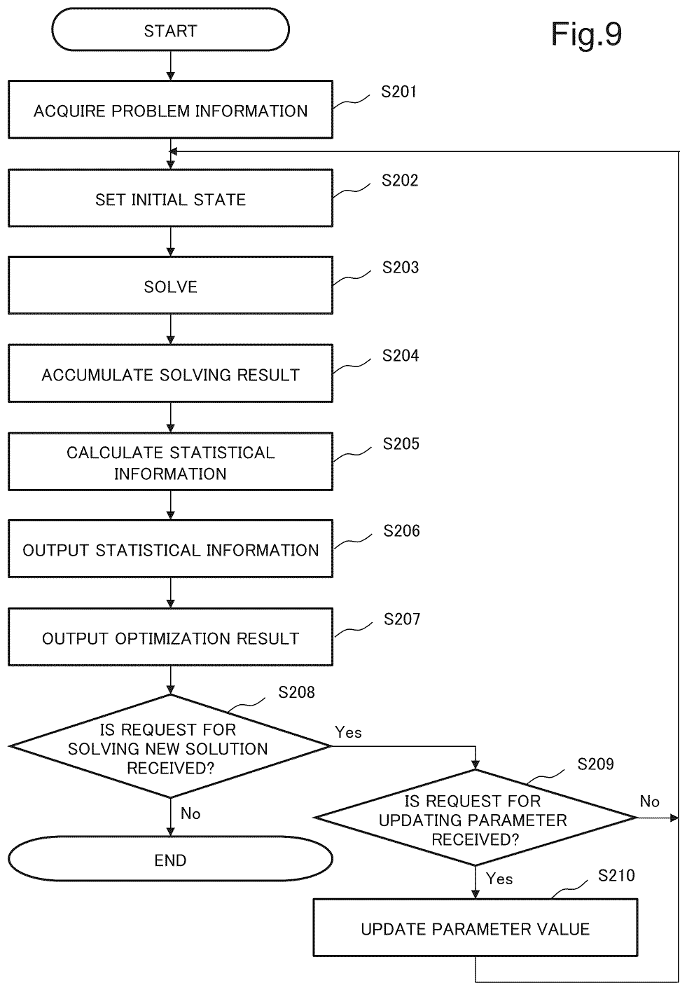

FIG. 9 is a flowchart illustrating a first operation example of the optimization system 20 of the present disclosure. First, the problem information acquisition unit 204 acquires problem information (step S201). The optimization processing unit 201 sets an initial state of the optimization problem represented by the problem information (step S202). Then, the optimization processing unit 201 solves the optimization problem represented by the problem information (step S203). The optimization processing unit 201 accumulates the solving results (step S204). The calculation unit 202 calculates statistical information (step S205). The output control unit 203 outputs the statistical information (step S206). The output control unit 203 outputs the optimization result (step S207). The reception unit 205 determines whether a new request for solving has been received (step S208).

Next, when a new request for solving the problem is received (step S208: Yes), the reception unit 205 determines whether a request for updating the parameter is received (step S209). When the parameter update request is received (step S209: Yes), the reception unit 205 updates the value of the received parameter (step S210), and the optimization processing unit 201 returns to step S202. When the parameter update request has not been received (step S209: No), the optimization processing unit 201 returns to step S202. In a case where a new request for solving has not been received (step S208: No), the optimization system 20 ends the processing.

### <Parallelization Example of Solving in Different Initial State>

Here, the optimization problem may be solved in parallel for a plurality of different initial states.

The optimization processing unit 201 solves the optimization problem in parallel for a plurality of different initial states.

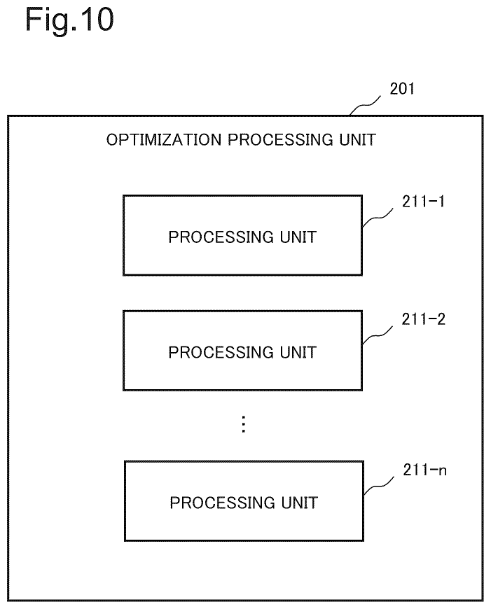

FIG. 10 is an explanatory diagram illustrating a detailed block diagram of the optimization processing unit in a case where the solving process is parallelized. The optimization processing unit 201 includes a plurality of processing units 211-1 to 211-n. The number of the processing units 211 is n, and n is an integer of 2 or more. The processing unit 211 solves the optimization problem in the designated initial state. The processing unit 211 may output, for example, an intermediate result of the solving.

Then, the calculation unit 202 calculates statistical information based on an intermediate result of parallel solving by the optimization processing unit 201. Specifically, for example, the calculation unit 202 may calculate the statistical information every time a result in a unit step is obtained by the processing unit 211.

Then, the output control unit 203 may present the statistical information to the user every time the statistical information is calculated. Alternatively, the output control unit 203 may present the statistical information in time series.

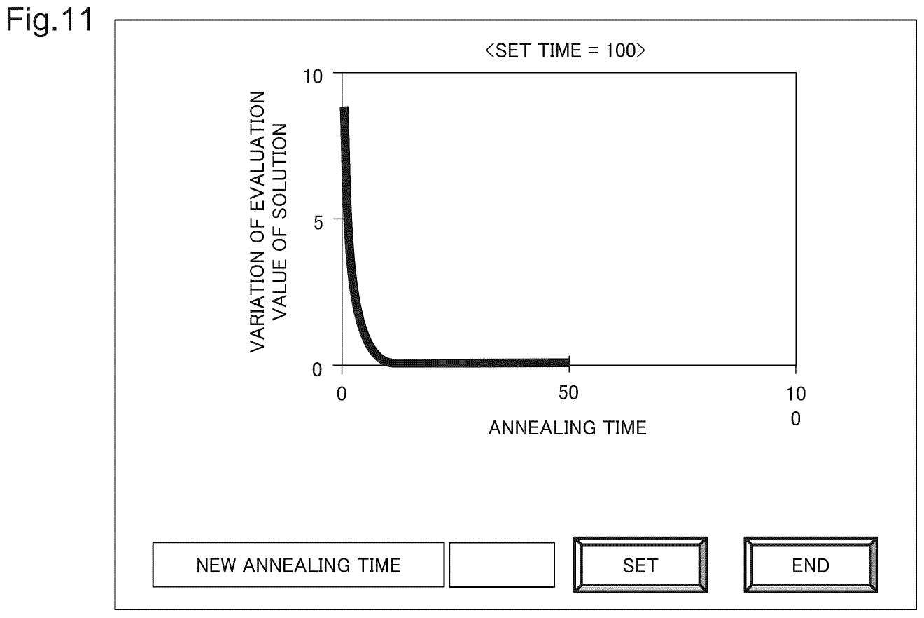

FIG. 11 is an explanatory diagram illustrating an example of displaying statistical information in real time. In FIG. 11, for example, the output control unit 203 displays a screen including a graph on the terminal device 21. In FIG. 11, in the graph, the vertical axis represents the variance of the evaluation value of the solution, and the horizontal axis represents the annealing time. The set time is 100. Referring to the graph, for example, the variance of the evaluation value of the solution approaches 0 with the lapse of time up to the set time 100. The user can presume that the solution is not improved even if the solving is continued. Therefore, the user may determine to terminate the solving.

For example, in FIG. 11, the screen includes an end button, an input field for a new annealing time, and a set button. When the end button is pressed, the reception unit 205 receives an end request for solving. For example, when the user determines to terminate the solving, the user may press the end button. Then, when the processing unit 211 of the optimization processing unit 201 receives the end request of the solving, the solving is ended.

For example, when the set button is pressed, the reception unit 205 receives the time input in the input field as a new annealing time. For example, when the user determines to update the annealing time, the user may input a new annealing time in the input field via the terminal device 21 and press the set button. Then, the setting unit 206 updates the annealing time to the received annealing time. Then, the processing unit 211 of the optimization processing unit 201 performs solving at the updated annealing time.

For example, in a case where the original set time is 100 and the current time is 50, when 55 is set as a new annealing time, the remaining 5 is performed. For example, in a case where the original set time is 100 and is currently ended up to 50, when 150 is set as a new annealing time, the remaining 100 is performed.

In the above example, an example has been described in which the optimization processing unit 201 performs parallelization by a plurality of different initial states, but the solving may be performed in parallel under a plurality of different constraint conditions. Then, the output control unit 203 may present statistical information of solutions of a plurality of different constraint conditions to the user. As a result, the user can efficiently search for hyperparameters. The optimization processing unit 201 may parallelize the solving by a plurality of different initial states for each of a plurality of different constraint conditions.

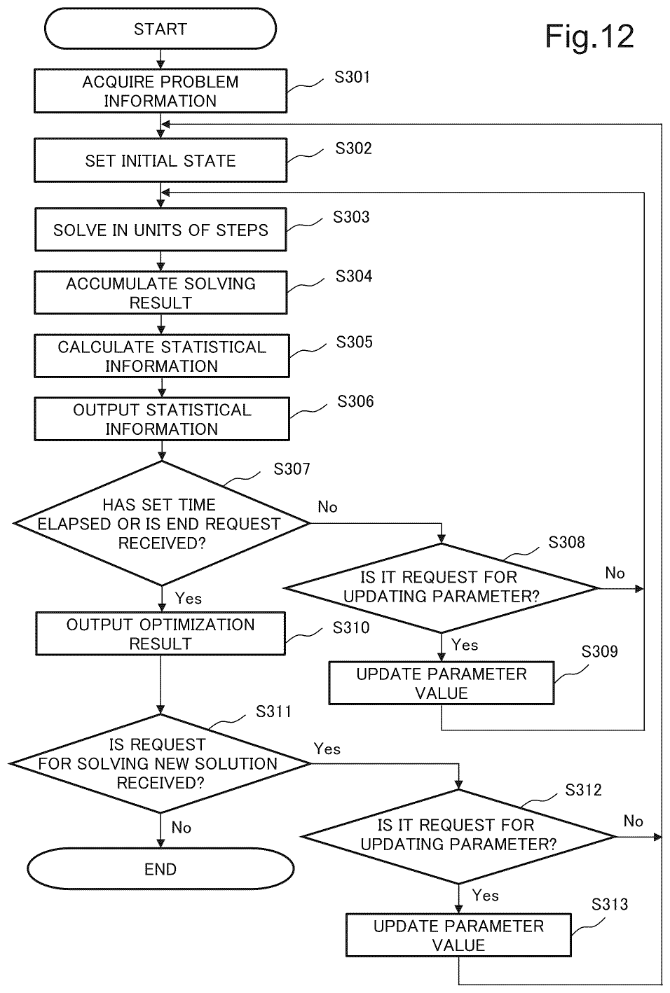

FIG. 12 is a flowchart illustrating a second operation example of the optimization system 20 of the present disclosure. In the second operation example, an example in which an optimization problem is executed for each unit step will be described.

First, the problem information acquisition unit 204 acquires problem information (step S301). The optimization processing unit 201 sets an initial state of the optimization problem represented by the problem information (step S302). Then, the optimization processing unit 201 solves the optimization problem represented by the problem information in units of steps (step S303). The optimization processing unit 201 accumulates the solving results (step S304). The calculation unit 202 calculates statistical information (step S305). The output control unit 203 outputs the statistical information (step S306).

The optimization processing unit 201 determines whether the set time has elapsed or the reception unit 205 has received the end request (step S307). When the set time has not elapsed and when the end request has not been received (step S307: No), the reception unit 205 determines whether the parameter update request has been received (step S308). When the parameter update request has not been received (step S308: No), the optimization processing unit 201 returns to step S303.

Next, when the parameter update request is received (step S308: Yes), the reception unit 205 updates the value of the received parameter (step S309), and the optimization processing unit 201 returns to step S303.

In a case where the set time has elapsed or in a case where the end request has been received (step S307: Yes), the output control unit 203 outputs the optimization result (step S310). The reception unit 205 determines whether anew request for solving has been received (step S311).

When a new request for solving the problem is received (step S311: Yes), the reception unit 205 determines whether a request for updating the parameter is received (step S312). When the parameter update request is received (step S312: Yes), the reception unit 205 updates the value of the received parameter (step S313), and the optimization processing unit 201 returns to step S302. When the parameter update request has not been received (step S312: No), the optimization processing unit 201 returns to step S302. When a new request for solving the problem has not been received (step S311: No), the optimization system 20 ends the process.

### <Automatic Adjustment of Parameters>

The optimization system 20 may automatically adjust the value of the parameter based on the statistical information in the current solving. Alternatively, the optimization system 20 may automatically determine whether to perform new solving based on the statistical information. Then, for example, when performing new solving, the setting unit 206 may automatically adjust the value of the parameter based on the statistical information.

First, an example of adjusting the value of the parameter in the current solving will be described. For example, the setting unit 206 adjusts the value of the parameter based on the statistical information. Here, the annealing time will be described as an example of the parameter. As an example of the statistical information, variance will be described as an example.

For example, if the variance is equal to or less than the threshold, the setting unit 206 changes the annealing time to be short. Here, shortening the annealing time includes the end of immediate solving. For example, the setting unit 206 may end the optimization problem by the optimization processing unit 201 if the variance is equal to or less than the threshold. There may be a plurality of thresholds. For example, the setting unit 206 may end the optimization problem by the optimization processing unit 201 in a case where the variance is equal to or less than a first threshold, and may set a new annealing time to be shorter than the set time by a predetermined time in a case where the variance is equal to or more than the first threshold and equal to or less than a second threshold larger than the first threshold.

The setting unit 206 may change the annealing time to be longer if the variance is not equal to or less than the threshold when the annealing time reaches a specific time. For example, the specific time may be a set time or a time based on the set time, such as a half of the set time. For example, if the variance is not equal to or less than the threshold even when the set time is reached, the setting unit 206 may increase the annealing time and further continue the optimization problem by the optimization processing unit 201.

Next, the setting unit 206 may determine whether to perform new solving based on the statistical information. Specifically, for example, when the variance is equal to or greater than the threshold, the setting unit 206 determines not to perform a new solving, and when the evaluation value of the solution is lower than the threshold, the setting unit determines to perform new solving. The setting unit 206 determines not to perform new solving when the evaluation value of the solution is equal to or greater than the threshold, and determines to perform new solving when the evaluation value of the solution is lower than the threshold. That is, the setting unit 206 determines whether a good solution has been obtained. If a good solution has been obtained, the setting unit determines not to perform new solving. If a good solution has not been obtained, the setting unit determines to perform new solving.

Then, for example, the setting unit 206 adjusts the value of the parameter based on the statistical information when performing new solving. The specific adjustment by the setting unit 206 may be the same as the example of adjusting the value of the parameter in the current solving.

Here, an example has been described in which new solving is automatically obtained when it is determined that new solving is to be obtained. For example, when the setting unit 206 determines to perform new solving, the output control unit 203 may recommend performing a new solution, and when the reception unit 205 receives a new solving request, the optimization processing unit 201 may perform a new solution.

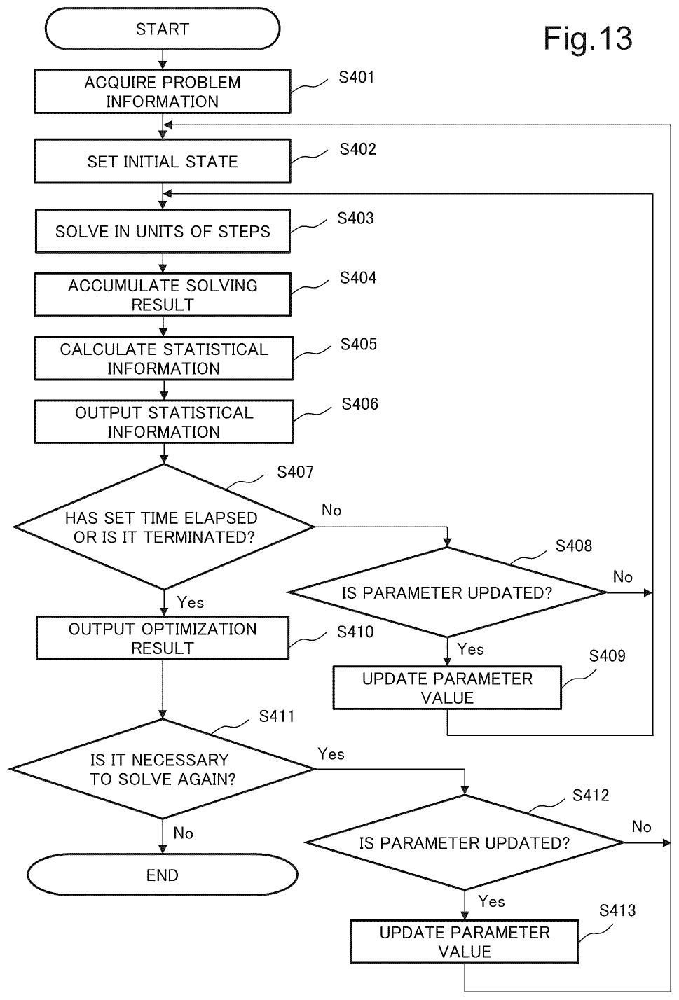

FIG. 13 is a flowchart illustrating a third operation example of the optimization system 20 of the present disclosure. First, the problem information acquisition unit 204 acquires problem information (step S401). The optimization processing unit 201 sets an initial state of the optimization problem represented by the problem information (step S402). For example, the optimization processing unit 201 sets different initial states for the plurality of processing units 211. Then, the optimization processing unit 201 solves the optimization problem represented by the problem information in units of steps (step S403). In step S403, each of the processing units 211 of the optimization processing unit 201 solves the optimization problem represented by the problem information in units of steps. As a result, solving is performed in parallel in different initial states.

Then, the optimization processing unit 201 accumulates the solving results (step S404). The calculation unit 202 calculates statistical information based on the intermediate result of the solving obtained in units of steps (step S405). The output control unit 203 outputs the statistical information (step S406).

The optimization processing unit 201 determines whether the set time has elapsed or the setting unit 206 may terminate the solving (step S407). When the set time has not elapsed and when it is determined that the solving is not to be ended (step S407: No), the setting unit 206 determines whether to update the parameter (step S408). In a case where it is not determined to update the parameter (step S408: No), the optimization processing unit 201 returns to step S403.

On the other hand, in a case where it is determined to update the parameter (step S408: Yes), the setting unit 206 updates the value of the parameter (step S409), and the optimization processing unit 201 returns to step S403.

When the set time has elapsed or when it is determined that the solving may be terminated (step S407: Yes), the output control unit 203 outputs an optimization result (step S410). The setting unit 206 determines whether the solving is necessary again (step S411).

Next, when it is determined that the lastly-redone solving is necessary (step S411: Yes), the setting unit 206 determines whether to update the parameter (step S412). In a case where it is determined not to update the value of the parameter (step S412: No), the optimization processing unit 201 returns to step S402. In a case where it is determined to update the parameter (step S412: Yes), the setting unit 206 updates the value of the parameter (step S413), and the optimization processing unit 201 returns to step S402. In a case where it is determined that the re-solving is not necessary (step S411: No), the optimization system 20 ends the processing.

As described above, in the second example embodiment, the optimization system 20 calculates the statistical information every time a new solution is calculated. As a result, it is possible to give an indication on the solution variation. Further, an indication can be provided for the setting of the parameters. For example, if the parameter is the annealing time, the user may consider that the annealing time is long and shorten the annealing time. As a result, the annealing time can be shortened. If the user considers that the annealing time is insufficient, the annealing time can be lengthened. As a result, the optimality of the solution can be improved.

The optimization system 20 solves the optimization problem in parallel for a plurality of different initial states, and calculates statistical information based on solutions obtained by solving the optimization problem a plurality of times calculated in parallel.

The optimization system 20 changes the value of the parameter in the heuristic solution based on the statistical information of the solution, and solves the optimization problem by the heuristic solution based on the changed value of the parameter. When the heuristic solution is the annealing method, the parameter is at least one of an annealing time, a transition degree of a stochastic transition in the optimization problem, and a degree of compliance of a constraint condition in the optimization problem. For example, if the parameter is the annealing time and the statistical information of the solution is the variance of the evaluation value of the solution, then the optimization system 20 changes the annealing time to be shorter if the variance is less than or equal to a threshold. On the other hand, the optimization system 20 may change the annealing time to be longer if the variance is not equal to or less than the threshold.

The description of each example embodiment is ended. Each example embodiment may be modified and used.

### Modification

For example, the value of the parameter may be recommended to the user using a learned model. For example, the optimization system 20 may further include a learning unit and a specification unit. Specifically, for example, the reception unit 205 receives the value of the parameter by the user's operation with respect to the output result output by the output control unit 203. Then, the reception unit 205 accumulates the values of the received parameter. Then, the learning unit may generate a model that learns the value of the parameter in the optimization problem based on the accumulated value of the parameter. Then, the specification unit specifies a value of the parameter candidate in the new solving by the generated model. The output control unit 203 may recommend the value of the specified parameter candidate to the user. Then, the reception unit 205 receives the value of a new parameter from the user.

The description of the modification is ended. Each example embodiment and modification may be used in appropriate combination.

In each example embodiment, the optimization system 20 may have a configuration including each functional unit and a part of information. For example, in the second example embodiment, the optimization system 20 may include an optimization processing unit 201, a calculation unit 202, an output control unit 203, a problem information acquisition unit 204, and a reception unit 205. The optimization system 20 may include an optimization processing unit 201, a calculation unit 202, an output control unit 203, a problem information acquisition unit 204, and a setting unit 206.

Each example embodiment is not limited to the example described above, and various modifications can be made. The configurations of the optimization systems 10 and 20 in the example embodiments are not particularly limited. For example, the optimization systems 10 and 20 may be achieved by one device such as one server. In a case where each functional unit of the optimization systems 10 and 20 is achieved by one device, for example, one device may be referred to as an optimization device, an information processing device, or the like, and is not particularly limited. Alternatively, the optimization system 20 in each example embodiment may be achieved by different devices for each function or data. For example, each functional unit may be configured by a plurality of servers and implemented as the optimization systems 10 and 20. For example, the optimization systems 10 and 20 may be achieved by a database server including each DB and a server including each functional unit. For example, each of the processing units 211 of the optimization system 20 may be achieved by different servers.

In each example embodiment, each piece of information or each DB may include a part of the above-described information. Each piece of information or each DB may include information other than the above-described information. Each piece of information or each DB may be divided into a plurality of DBs or a plurality of pieces of information in more detail. As described above, a method of implementing each piece of information or each DB is not particularly limited.

Each screen is an example, and is not particularly limited. In each screen, a button, a list, a check box, an information display field, an input field, and the like (not illustrated) may be added. The background color of the screen and the like may be changed.

The process of generating information or the like to be displayed on the terminal device 21 may be performed by the output control units 103 and 203. For example, this process may be performed by the terminal device 21.

### Application Example

Here, as an application example, arrangement optimization of a medical worker such as a nurse or a doctor will be described. Specifically, an application example of determining a work shift using an optimization system will be described. This application example may be applied to the configuration of the first example embodiment.

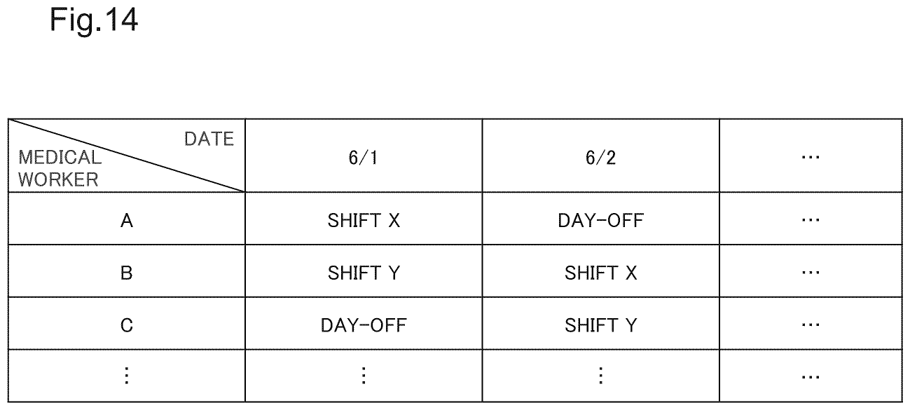

FIG. 14 is an example of a table representing work shifts of a medical worker belonging to a certain organization. Specifically, FIG. 14 illustrates an example of a work shift in a target period (here, June) of all medical workers belonging to a certain organization including medical workers A to C. The generation of such a work shift can be formulated as an optimization problem. For example, any strict solution can be applied as a mixed integer programming problem, or an annealing method can be applied as a large-scale discrete optimization problem.

Hereinafter, a flow of determining the work shift including the input by the medical worker will be described.

First, each medical worker to be subjected to a work shift logs in an artificial intelligence (AI) system (work shift management system) implemented by an optimization system using a terminal device, and inputs a desired work schedule. Then, the AI system considers a desired work schedule or the like input by each medical worker (nurse or doctor) as a constraint condition, and generates an optimal work shift (see FIG. 14).

In this case, the AI system sets an optimization problem in which a work form (necessity of work or the like) for each date of each medical worker is set as a determination variable, and congeniality, a human relationship, or the like between the medical workers is set as a constraint condition in addition to the desired work schedule or the like, and an information processing device such as the optimization systems 10 and 20 described in the present example embodiment generates a work shift based on a final output solution of the optimization problem. Then, the work shift generated by the AI system is notified to each medical worker by being displayed on a terminal device or the like. Then, each medical worker checks the generated work shift, logs in the AI system if there is no problem with the generated work shift, and performs an input for approving the work shift with the terminal device. On the other hand, in a case where it is determined that there is a problem in the generated work shift, each medical worker logs in to the AI system and inputs a correction request using the terminal device. When detecting that there is a correction request from the medical worker, the AI system adds a new constraint condition based on the correction request and corrects the optimization problem. The above-described addition of the constraint condition or the like may be executed based on a user input or the like of the administrator of the AI system who has confirmed the correction request. Then, the AI system obtains a final output solution of the corrected optimization problem, and generates a work shift indicated by the final output solution. Then, when a work shift approved by all the target medical workers is generated, the AI system determines the work shift as a final work shift.

In this way, by using the information processing device for work shift generation, it is possible to support the decision making of the administrator in the medical facility.

### (Exemplary Hardware Configuration of Computer)

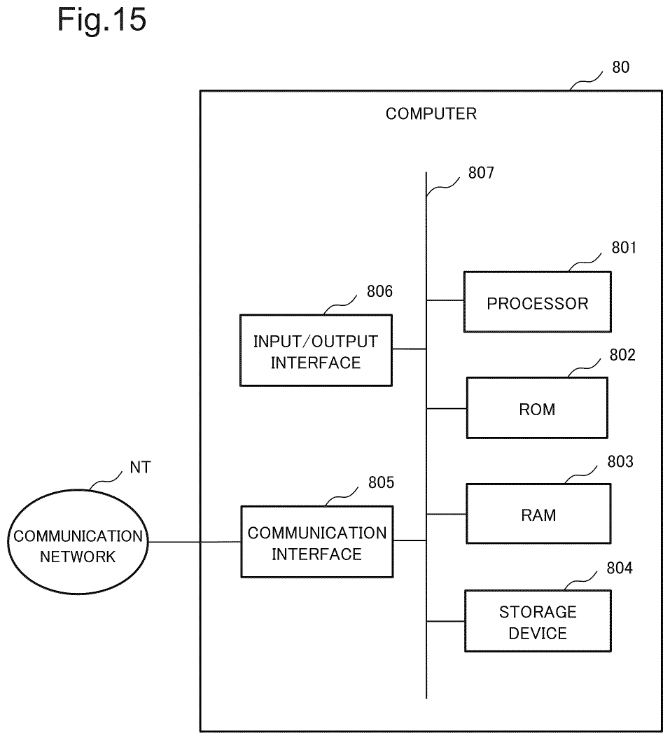

Next, an exemplary hardware configuration in a case where each device such as the optimization system described in each example embodiment is achieved by a computer will be described. FIG. 15 is an explanatory diagram illustrating an exemplary hardware configuration of a computer. For example, some or all of the devices can be achieved by using an arbitrary combination of a computer 80 and a program as illustrated in FIG. 5.

The computer 80 includes, for example, a processor 801, a read only memory (ROM) 802, a random access memory (RAM) 803, and a storage device 804. The computer 80 includes a communication interface 805 and an input/output interface 806. The components are connected via, for example, a bus 807. The number of components is not particularly limited, and each component is one or more.

The processor 801 controls the entire computer 80. As the processor 801, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, or a combination thereof can be used. The computer 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

The processor 801 loads a program stored in the storage device 804, the ROM 802, or the like. Then, the processor 801 executes each process coded in the program. The processor 801 may download various programs via the communication network NT. The processor 801 functions as a part or all of the computer 80. Then, the processor 801 may execute processing or instructions in the illustrated flowchart based on the program.

The communication interface 805 is connected to a communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. Then, the communication interface 805 controls input and output of data from an external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a voice output device that outputs voice. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 15. The computer 80 may have components other than those illustrated in FIG. 15. For example, the computer 80 may include a drive device or the like. Then, the processor 801 may read a program or data stored in a recording medium attached to a drive device or the like into the RAM 803. Examples of the non-transitory tangible recording medium include an optical disk, a flexible disk, a magnetic optical disk, and a universal serial bus (USB) memory. As described above, for example, the computer 80 may include an input device such as a keyboard and a mouse. The computer 80 may have an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

This is the end of the description of the hardware configuration of each device. There are various modifications of the method of achieving each device. For example, each device may be achieved by an arbitrary combination of a computer and a program different for each component. A plurality of components included in each device may be achieved by any combination of one computer and a program.

A part or all of each component of each device may be achieved by an application specific circuit. A part or all of each component of each device may be achieved by a general-purpose circuit including a processor such as a field programmable gate array (FPGA). A part or all of each component of each device may be achieved by a combination of an application specific circuit, a general-purpose circuit, or the like. These circuits may be a single integrated circuit. Alternatively, these circuits may be divided into a plurality of integrated circuits. The plurality of integrated circuits may be configured by being connected via a bus or the like.

In a case where a part or all of each component of each device is achieved by a plurality of computers, circuits, and the like, the plurality of computers, circuits, and the like may be arranged in a centralized manner or in a distributed manner.

The optimization method described in each example embodiment is achieved by the optimization system. For example, the optimization method is achieved by a computer such as a server or a terminal device 21 executing a program prepared in advance.

The program described in each example embodiment is recorded in a computer-readable recording medium such as an HDD, an SSD, a flexible disk, an optical disk, a magnetic optical disk, and a USB memory. Then, the program is executed by being read from the recording medium by the computer. The program may be distributed via the communication network NT.

Each component of the optimization system in each example embodiment described above may be achieved by dedicated hardware such as a computer. Alternatively, each component may be achieved by software. Alternatively, each component may be achieved by a combination of hardware and software.

For example, in a heuristic solution such as an annealing method, a stochastic operation is included, so that the obtained solution is different every time the optimization problem is solved. Therefore, there is a problem that it is difficult to understand the optimality of the solution obtained by the optimization problem.

According to the present disclosure, it is possible to facilitate confirmation of optimality of a solution obtained by an optimization problem in a heuristic solution.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. For example, the present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Further, it is noted that the inventor's intent is to retain all equivalents of the claimed invention even if the claims are amended during prosecution.

A part or all of the above example embodiments can also be described as the following Supplementary Notes. However, a part or all of the above example embodiments are not limited to the following.

### (Supplementary Note 1)

An optimization system including:
an optimization processing means that solves an optimization problem by a heuristic solution;
a calculation means that calculates statistical information of a solution based on the solution obtained by the optimization processing means; and
an output control means that presents the statistical information to a user.

### (Supplementary Note 2)

The optimization system according to Supplementary Note 1, in which
the statistical information is at least one of a variance of the solution, a confidence interval, a standard deviation, an average value, a median value, and a histogram of the solution and a frequency of the solution.

### (Supplementary Note 3)

The optimization system according to Supplementary Note 1 or 2, in which
the statistical information is statistical information of an evaluation value of the solution.

### (Supplementary Note 4)

The optimization system according to any one of Supplementary Notes 1 to 3, in which
the optimization processing means repeatedly performs the solving, and
the calculation means calculates the statistical information every time the optimization processing means calculates a new solution.

### (Supplementary Note 5)

The optimization system according to any one of Supplementary Notes 1 to 4, in which
the optimization processing means solves the optimization problem in parallel for a plurality of different initial states, and
the calculation means calculates the statistical information based on an intermediate result of parallel solving by the optimization processing means.

### (Supplementary Note 6)

The optimization system according to any one of Supplementary Notes 1 to 5, in which
a setting means configured to change a value of a parameter in the heuristic solution based on the statistical information of the solution, and
the optimization processing means solves the optimization problem by the heuristic solution based on a changed value of the parameter.

### (Supplementary Note 7)

The optimization system according to Supplementary Note 6, in which
the heuristic solution is an annealing method, and
the parameter is at least one of an annealing time, a transition degree of a stochastic transition in the optimization problem, and a degree of compliance of a constraint condition in the optimization problem.

### (Supplementary Note 8)

The optimization system according to Supplementary Note 6 or 7, in which
the heuristic solution is an annealing method,
the parameter is an annealing time,
the statistical information is a variance of an evaluation value of the solution, and
the setting means changes the annealing time to be short when the variance is equal to or less than a threshold.

### (Supplementary Note 9)

The optimization system according to Supplementary Note 6 or 7, in which
the heuristic solution is an annealing method,
the parameter is an annealing time,
the statistical information is a variance of an evaluation value of the solution, and
the setting means changes the annealing time to be long when the variance is larger than a threshold.

### (Supplementary Note 10)

The optimization system according to any one of Supplementary Notes 1 to 6, in which
the heuristic solution is an annealing method.

### (Supplementary Note 11)

An optimization method including:
solving an optimization problem by a heuristic solution;
calculating statistical information of a solution based on the solution obtained by the solving; and
presenting the statistical information to a user.

### (Supplementary Note 12)

A program for executing:
solving an optimization problem by a heuristic solution;
calculating statistical information of a solution based on the solution obtained by the solving; and
presenting the statistical information to a user.

### (Supplementary Note 13)

A non-transitory computer-readable recording medium that records a program for causing a computer to execute:
solving an optimization problem by a heuristic solution;
calculating statistical information of a solution based on the solution obtained by the solving; and
presenting the statistical information to a user.

### REFERENCE SIGNS LIST

10, 20 optimization system
21 terminal device
80 computer
101, 201 optimization processing unit
102, 202 calculation unit
103, 203 input/output control unit
204 problem information acquisition unit
205 reception unit
206 setting unit
211, 211-1 to 211-n processing unit
801 processor
802 ROM
803 RAM
804 storage device
805 communication interface
806 input/output interface
807 bus
NT communication network

1. An optimization system comprising:
at least one memory configured to store instructions; and
at least one processor configured to execute the instructions to:
solve an optimization problem by a heuristic solution;
calculate statistical information of a solution based on the solution obtained by solving; and
output the statistical information to a terminal device of a user.

2. The optimization system according to claim 1, wherein
the statistical information is at least one of a variance of the solution, a confidence interval, a standard deviation, an average value, a median value, and a histogram of the solution and a frequency of the solution.

3. The optimization system according to claim 1, wherein
the statistical information is statistical information of an evaluation value of the solution.

4. The optimization system according to claim 1, wherein
the at least one processor is further configured to execute the instructions to:
repeatedly perform solving; and
calculate the statistical information every time a new solution is calculated by solving.

5. The optimization system according to claim 1, wherein
the at least one processor is further configured to execute the instructions to:
solve the optimization problem in parallel for a plurality of different initial states; and
calculate the statistical information based on an intermediate result of parallel solving.

6. The optimization system according to claim 1, wherein
the at least one processor is further configured to execute the instructions to:
change a value of a parameter in the heuristic solution based on the statistical information of the solution; and
solve the optimization problem by the heuristic solution based on a changed value of the parameter.

7. The optimization system according to claim 6, wherein
the heuristic solution is an annealing method, and
the parameter is at least one of an annealing time, a transition degree of a stochastic transition in the optimization problem, and a degree of compliance of a constraint condition in the optimization problem.

8. The optimization system according to claim 6, wherein
the heuristic solution is an annealing method,
the parameter is an annealing time,
the statistical information is a variance of an evaluation value of the solution, and
the at least one processor is further configured to execute the instructions to:
when the variance is equal to or less than a threshold, change the annealing time to be short.

9. The optimization system according to claim 6, wherein
the heuristic solution is an annealing method,
the parameter is an annealing time,
the statistical information is a variance of an evaluation value of the solution, and
the at least one processor is further configured to execute the instructions to:
when the variance is larger than a threshold, change the annealing time to be long.

10. The optimization system according to claim 1, wherein
the heuristic solution is an annealing method.

11. An optimization method implemented by one or more processors and comprising:
solving an optimization problem by a heuristic solution;
calculating statistical information of a solution based on the solution obtained by the solving; and
outputting the statistical information to a terminal device of a user.

12. A non-transitory computer-readable recording medium that records a program for causing a computer to execute:
solving an optimization problem by a heuristic solution;
calculating statistical information of a solution based on the solution obtained by the solving; and
outputting the statistical information to a terminal device of a user.
